(19) United States
(12) Patent Application Publication
(10) Pub. No.: US 2018/0066620 A1
(43) Pub. Date: Mar. 8, 2018

(54) FUEL INJECTION VALVE

(71) Applicant: HITACHI AUTOMOTIVE SYSTEMS, LTD., Hitachinaka-shi, Ibaraki (JP)

(72) Inventors: Masaki NAGAOKA, Maebashi-shi, Gunma (JP); Nobuaki KOBAYASHI, Maebashi-shi, Gunma (JP); Ryuta KINOSHITA, Mito-shi, Ibaraki (JP)

(73) Assignee: HITACHI AUTOMOTIVE SYSTEMS, LTD., Hitachinaka-shi, Ibaraki (JP)

(21) Appl. No.: 15/554,045

(22) PCT Filed: Feb. 5, 2016
(86) PCT No.: PCT/JP2016/053504

§ 371 Date: Aug. 28, 2017

(30) Foreign Application Priority Data
Mar. 11, 2015 (JP) 2015-047890

(51) Int. Cl. F02M 61/18; F02M 61/16; F02M 63/00; F02M 51/06

(52) U.S. Cl. CPC F02M 61/1806; F02M 51/061; F02M 63/0031; F02M 61/162

(57) ABSTRACT

Disclosed is a fuel injection valve comprising: a fuel injection orifice provided in a downstream side of a valve seat which a valve body moves toward and away from; a swirl chamber having a swirl passage formed around the entry opening of the fuel injection orifice; and a transverse passage whose end is opened in an inner circumferential wall of the swirl chamber in order to provide a fuel into the swirl chamber, wherein a center of the entry opening is shifted from a first position where the velocity component in the swirl direction of the fuel can be maximized to a second position where the velocity component in the swirl direction is reduced, and where a velocity component in a center axis direction of the fuel injection orifice is enhanced. Thereby, it is possible to easily adjust a fuel injection amount and a spray angle.

### TECHNICAL FIELD

The present invention relates to a fuel injection valve that generates swirl fuel at an upstream side of a fuel injection orifice and injects the swirl fuel from the fuel injection orifice.

### BACKGROUND ART

As a background art of the technical field relating to the present invention, a fuel injection valve disclosed in Japanese Patent Provisional Publication No. 2003-336562 (Patent Document 1) is known. This fuel injection valve has a valve seat member; a transverse passage that communicates with a downstream end of the valve seat; and a swirl chamber in which a downstream end of the transverse passage opens in a tangential direction. Furthermore, the transverse passage and the swirl chamber are provided between the valve seat member and an injector plate coupled to a front end surface of the valve seat member. The injector plate has each of fuel injection orifices which jets fuel having gotten a swirl in the swirl chamber. In the fuel injection valve, the fuel injection orifice is offset by a predetermined distance from a center of the swirl chamber toward an upstream end side of the transverse passage (see abstract). With this structure, atomization of the injected fuel is promoted, and a fuel injection response is improved.

However, in the fuel injection valve for jetting a fuel wherein the transverse passage, the swirl chamber, and the fuel injection orifice are formed on the injector plate, generally a spray angle is set by adjusting a diameter and length of the fuel injection orifice and a size (diameter) of the swirl chamber. If any one of the diameter and length of the fuel injection orifice or the size (diameter) of the swirl chamber is changed in order to adjust the spry angle, an amount of fuel jetted from the fuel injection orifice (fuel injection amount) is changed. Therefore, a long times have been spent on determining the diameter and length of the fuel injection orifice and the size (diameter) of the swirl chamber so that both of the fuel injection amount and the spray angle are kept within the predetermined range.

### PRIOR ART DOCUMENT

### Patent Document

Patent Document 1: Japanese Patent Provisional Publication No. 2003-336562

### SUMMARY OF THE INVENTION

It is an object of the present invention to provide a fuel injection valve in which a fuel injection amount and a spray angle can be adjusted easily.

In order to achieve the above object, according to one aspect of the present invention, a fuel injection valve comprises:
a valve body;
a fuel injection orifice provided in a downstream side of a valve seat which the valve body moves toward and away from;
a swirl chamber having a bottom surface on which an entry opening of the fuel injection orifice opens and an inner circumferential wall surrounding the bottom surface, the swirl chamber having:
   a swirl passage for a fuel, the swirl passage formed between the inner circumferential wall and the entry opening; and
a transverse passage whose downstream end is opened in the inner circumferential wall of the swirl chamber in order to provide the fuel into the swirl chamber, the transverse passage having:
   one width direction end part connected to an upstream side of the inner circumferential wall in a flow direction of a swirl fuel; and
   the other width direction end part connected to a downstream side of the inner circumferential wall in the flow direction of the swirl fuel, and
      when imaging an extension line formed by extending the other width direction end part of the transverse passage to a swirl chamber side, and a straight line segment passing a center of the swirl chamber and being perpendicular to the extension line,
      a center of the entry opening of the fuel injection orifice being positioned to be shifted from the center of the swirl chamber along the extension line, and in two areas formed by dividing the swirl chamber into two with the straight line segment, the center of the entry opening of the fuel injection orifice being arranged in an area opposite to an area to which the transverse passage is connected.

According to another aspect of the invention, a fuel injection valve comprises:
a valve body;
a fuel injection orifice provided in a downstream side of a valve seat which the valve body moves toward and away from;
a swirl chamber having an entry opening of the fuel injection orifice and a swirl passage for a fuel, the swirl passage formed around the entry opening;
a transverse passage to provide the fuel into the swirl chamber; and
a nozzle plate on which the fuel injection orifice, the swirl chamber, and the transverse passage are formed,
   wherein:
   in flow passage width which is formed in both side of the entry opening on a line segment passing a center of the entry opening of the fuel injection orifice and a center of the nozzle plate, the flow passage width in the upstream side in the flow direction of the swirl fuel is smaller than the flow passage width in the downstream side in the flow direction of the swirl fuel.

Furthermore, according to another aspect of the invention, a fuel injection valve comprises:
a valve body;
a fuel injection orifice provided in a downstream side of a valve seat which the valve body moves toward and away from;
a swirl chamber having an entry opening of the fuel injection orifice and a swirl passage for a fuel, the swirl passage formed around the entry opening; and
a transverse passage to provide the fuel into the swirl chamber,
   wherein:
   a center of the entry opening of the fuel injection orifice is arranged to be shifted from a first position to a second position,

the first position being a position where a velocity component in a swirl direction of a fuel flowing into the fuel injection orifice is max,

the second position being a position where the velocity component in the swirl direction gets small and where a velocity component in a center axis direction of the fuel injection orifice gets large.

According to the present invention, it is possible to largely change the spray angle while reducing a change rate of the fuel injection amount. Therefore, it is possible to provide a fuel injection valve being capable of providing a desired fuel injection amount and spray angle by easily adjusting the fuel injection amount and the spray angle. Thereby, design or design change of the fuel injection valve is simplified.

### BRIEF EXPLANATION OF THE DRAWINGS

FIG. 1 is a longitudinal section drawing showing a cross section taken along a valve axis (a center axis line) of the fuel injection valve, according to the present invention.

FIG. 2 is a longitudinal section drawing enlargedly showing a vicinity (a nozzle part) of a valve part and a fuel injection part of the fuel injection valve shown in FIG. 1 (corresponding to a cross section taken along a line II-II in FIG. 3).

FIG. 3 is a plan view of the nozzle plate viewed from a line III-III in FIG. 1.

FIG. 4 is a plan view enlargedly showing a swirl chamber and a fuel injection orifice (an enlarged plan view of IV area in FIG. 3).

FIG. 5 is a drawing showing an analytical result of a fuel flow at a cross section taken along a line V-V in FIG. 4.

FIG. 6 is a longitudinal section drawing (a cross section taken along a V-V line in FIG. 4) showing a fuel liquid film distribution in an inside of the fuel injection orifice and a vicinity thereof, when arranging an entry opening of the fuel injection orifice in a center of the swirl chamber.

FIG. 7 is a longitudinal section drawing (a cross section taken along a V-V line in FIG. 4) showing a fuel liquid film distribution in an inside of the fuel injection orifice and a vicinity thereof, when arranging an entry opening to be shifted to area A3 side from the center of the swirl chamber.

FIG. 8 is a drawing showing an analytical result of a change rate of flow volume in the embodiment of the present invention, when a position of the entry opening of the fuel injection orifice is changed.

FIG. 9 is a drawing showing an analytical result of a change rate of spray angle in the embodiment of the present invention, when a position of the entry opening of the fuel injection orifice is changed.

FIG. 10 is a plan view showing a configuration of a transverse passage, a swirl chamber, and a fuel injection orifice in a comparative example.

FIG. 11 is a drawing showing an analytical result of a fuel flow at a cross section taken along a line VII-VII in FIG. 10.

FIG. 12 is a plan view enlargedly showing a swirl chamber and a fuel injection orifice in an example where a shape of the swirl chamber is modified (the enlarged plan view of IV area in FIG. 3).

FIG. 13 is a plan view showing an example where a position of the fuel injection valve with respect to the swirl chamber is changed in the modified example of FIG. 12.

FIG. 14 is a plan view enlargedly showing the swirl chamber and the fuel injection orifice in the example where the shape of the swirl chamber is further modified (the enlarged plan view of IV area in FIG. 3).

FIG. 15 is a cross section of an internal combustion engine in which the fuel injection valve is mounted.

### DESCRIPTION OF THE EMBODIMENTS

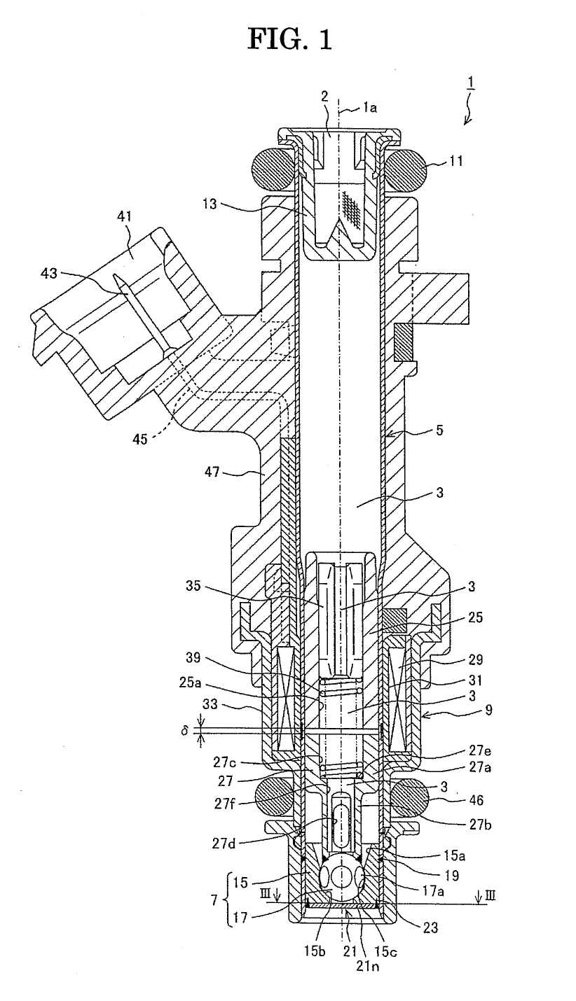

An embodiment of the present invention will be explained below with reference to FIGS. 1 to 8.

A whole configuration of a fuel injection valve 1 will be explained using FIG. 1. FIG. 1 is a longitudinal section drawing showing a cross section taken along a center axis line 1a of the fuel injection valve 1, according to the present embodiment. The center axis line 1a coincides with an axis (valve axis) of a movable element 27 to which an after-mentioned valve body 17 is integrally fixed. The center axis line 1a also coincides with a center axis line of an after-mentioned cylindrical body 5, and further coincides with each center line of an after-mentioned valve seat 15b and a nozzle plate 21n.

The fuel injection valve 1 is provided with the metal-made cylindrical body 5 extending from an upper end portion to a lower end portion of the fuel injection valve 1. A fuel flow passage 3 is formed inside the cylindrical body 5 so as to extend substantially along the center axis line 1a. In FIG. 1, the upper end portion (an upper end side) is called a base end portion (a base end side), and the lower end portion (a lower end side) is called a top end portion (a top end side). These terms “base end portion (base end side)” and “top end portion (top end side)” are based on a flow direction of fuel or a fixing structure to a fuel pipe (not shown). That is, the base end portion is an upstream side in the fuel flow direction, and the top end portion is a downstream side in the fuel flow direction. Furthermore, in the present description, for convenience of explanation, upper and lower positions of each element or component are defined based on FIG. 1, and these upper and lower positions have nothing to do with up and down directions in a mounting state of the fuel injection valve 1 in an internal combustion engine.

The cylindrical body 5 is provided, at a base end portion thereof, with a fuel supply port 2. A fuel filter 13 is fixed to the fuel supply port 2. The fuel filter 13 is a member to filter out foreign particles included in the fuel.

The cylindrical body 5 is further provided, at the base end portion thereof, with an O-ring 11. The O-ring 11 functions as a sealing member when the fuel injection valve 1 is connected to the fuel pipe.

At a top end portion of the cylindrical body 5, a valve part 7 formed by the valve body 17 and a valve seat member 15 is formed. The valve seat member 15 has a step-shaped valve body accommodating hole 15a to accommodate the valve body 17. A conical surface is formed at a certain position inside the valve body accommodating hole 15a, and the valve seat (seal part) 15b is formed on this cone-shaped surface. A guide surface 15c to guide movement of the valve body 17 in a direction along the center axis line 1a is formed at an upstream side (a base end side) with respect to the valve seat 15b in the valve body accommodating hole 15a. In conjunction with the valve seat 15b and the valve body 17, a fuel passage is opened and closed. More specifically, when the valve body 17 is seated on the valve seat 15b, the fuel passage is closed, and when the valve body 17 separates from the valve seat 15b, the fuel passage is opened.

The valve seat member 15 is inserted to a top end inner side of the cylindrical body 5, and is fixed to the cylindrical body 5 by laser welding. The laser welding 19 is performed throughout an entire circumference of the cylindrical body 5 from an outer circumferential side of the cylindrical body 5. The valve body accommodating hole 15a penetrates the valve seat member in the direction along the center axis line 1a. A nozzle plate 21n is fixed to a lower end surface (a top end surface) of the valve seat member 15. The nozzle plate 21n closes an opening of the valve seat member 15 which is formed by the valve body accommodating hole 15a.

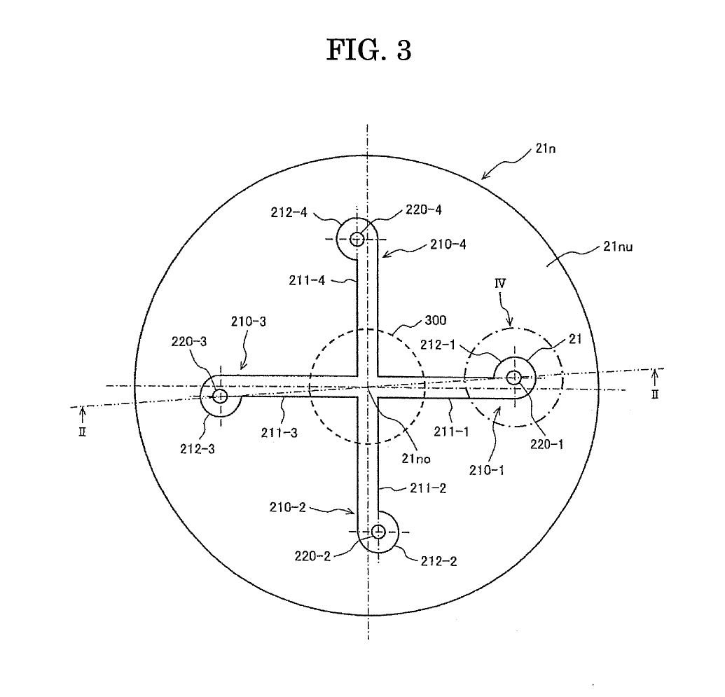

In the present embodiment, a fuel injection part 21 that jets swirl fuel is formed by the valve seat member 15 and the nozzle plate 21n. The nozzle plate 21n is fixed to the valve seat member 15 by laser welding. The laser welding portion 23 is performed throughout a circumference of an injection orifice providing area where fuel injection orifices 220-1, 220-2, 220-3 and 220-4 (see FIG. 3) are formed, so as to surround the injection orifice providing area. The valve seat member 15 can be fixed to the cylindrical body 5 by laser welding after being inserted and press-fitted to the top end inner side of the cylindrical body 5.

In the present embodiment, as the valve body 17, a ball valve having a spherical shape is used. Therefore, a plurality of cutting surfaces 17a are formed at some intervals in a circumferential direction of the valve body 17 at a portion facing the guide surface 15c of the valve seat member 15. These cutting surfaces 17a give clearances between an inner circumferential surface of the valve seat member 15 and the valve body 17, and the fuel passage is formed by these clearances. Here, the valve body 17 can be formed by an element other than the ball valve. For instance, a needle valve can be used.

In the present embodiment, the valve part 7 including the valve seat member 15 and the valve body 17, and the nozzle plate 21n form a nozzle part to jet the fuel. The nozzle plate 21n where after-mentioned fuel injection orifice 220 and swirl passage 210 (a transverse passage 211 and a swirl chamber 212) are formed is fixed to a top end surface of a nozzle part body (valve seat member 15) having the valve part 7.

A driving part 9 to drive the valve body 17 is disposed at a middle part of the cylindrical body 5. The driving part 9 is formed by an electromagnetic actuator. More specifically, the driving part 9 is formed by a fixed core 25, the movable element (a movable member) 27, an electromagnetic coil 29, and a yoke 33.

The fixed core 25 is made of magnetic metal material, and is press-fixed to an inside at the longitudinal direction middle part of the cylindrical body 5. The fixed core 25 is cylindrical in shape, and has a penetration hole 25a that penetrates the middle of the fixed core 25 in the direction along the center axis line 1a. The fixed core 25 can be fixed to the cylindrical body 5 by welding, or can be fixed to the cylindrical body 5 by press-fitting and the welding.

The movable element 27 is disposed at a top end side with respect to the fixed core 25 in the cylindrical body 5. A movable core 27a is provided at a base end side of the movable element 27. The movable core 27a faces the fixed core 25 through a slight gap δ. The movable element 27 is provided, at a top end side thereof, with a small diameter part 27b, and the valve body 17 is fixed to a top end of this small diameter part 27b by welding. In the present embodiment, the movable core 27a and the small diameter part 27b are integrally formed (as an integral member made of the same material). However, these two elements can be separately provided and fixed together. The movable element 27 has the valve body 17, and moves the valve body 17 in a valve open/closure direction. The valve body 17 touches (is seated on) the valve seat member 15, and also an outer circumferential surface of the movable core 27a touches an inner circumferential surface of the cylindrical body 5, thereby supporting and guiding movement in the direction along the center axis line 1a (in the valve open/closure direction) of the movable element 27 at these two points in the valve axis direction.

The movable core 27a is provided, at an end surface thereof which faces the fixed core 25, with a depressed portion 27c. A spring seat 27e of a spring (a coil spring) 39 is formed on a bottom surface of the depressed portion 27c. At an inner circumferential side of the spring seat 27e, a penetration hole 27f is formed so as to penetrate the small diameter part (the connecting part) 27b up to a top end side end portion of the small diameter part (the connecting part) 27b along the center axis line 1a. Furthermore, the small diameter part 27b is provided, at a side surface thereof, with an opening portion 27d. The penetration hole 27f opens to a bottom surface of the depressed portion 27c, and also the opening portion 27d opens to an outer circumferential surface of the small diameter part 27b, thereby forming the fuel flow passage 3 that communicates with the fuel passage 3 formed at the fixed core 25 and the valve part 7.

The electromagnetic coil 29 is inserted or fitted onto an outer circumference of the cylindrical body 5 in a position in which the fixed core 25 and the movable core 27a face each other through the slight gap δ. The electromagnetic coil 29 is wound around a tubular bobbin 31 that is made of resin material, and then is inserted or fitted onto the outer circumference of the cylindrical body 5. The electromagnetic coil 29 is electrically connected, through a wiring member 45, to a connector pin 43 that is provided at a connector 41. A driving circuit (not shown) is connected to the connector 41, and a driving current flows to the electromagnetic coil 29 through the connector pin 43 and the wiring member 45.

The yoke 33 is made of magnetic metal material. The yoke 33 is disposed at an outer circumferential side of the electromagnetic coil 29 so as to encircle the electromagnetic coil 29, and serves as a housing of the fuel injection valve 1. Furthermore, a lower end portion of the yoke 33 faces the outer circumferential surface of the movable core 27a through the cylindrical body 5, then in cooperation with the movable core 27a and the fixed core 25, the yoke 33 forms a closed magnetic path where magnetic flux generated by current supply to the electromagnetic coil 29 flows.

The coil spring 39 is set in a compressed state from the penetration hole 25a of the fixed core 25 to the depressed portion 27c of the movable element 27. The coil spring 39 functions as a forcing member that forces the movable element 27 in a direction (in a valve closure direction) in which the valve body 17 touches (is seated on) the valve seat 15b. An adjuster (an adjusting element) 35 is disposed inside the penetration hole 25a of the fixed core 25. A base end side end portion of the coil spring 39 touches a top end side end surface of the adjuster 35. By adjusting a position of the adjuster 35 in the direction along the center axis line 1a in the penetration hole 25a, an urging force of the movable element 27 (i.e. the valve body 17) by the coil spring 39 is adjusted.

The adjuster 35 has the fuel flow passage 3 that penetrates the middle of the adjuster 35 in the direction along the center axis line 1a. After the fuel flows in the fuel flow passage 3 of the adjuster 35, the fuel flows to the fuel flow passage 3 of a top end side portion of the penetration hole 25a of the fixed core 25, and then flows in the fuel flow passage 3 formed in the movable element 27.

The cylindrical body 5 is provided, at the top end portion thereof, with an O-ring 46. The O-ring 46 functions as a seal that air-tightly and liquid-tightly seals a gap between an inner circumferential surface of an insertion port 109a (see FIG. 5) formed at the internal combustion engine side and an outer circumferential surface of the yoke 33 when the fuel injection valve 1 is mounted in the internal combustion engine.

The fuel injection valve 1 is molded and covered by a resin cover 47 from the middle up to an almost base end side end portion of the fuel injection valve 1. A top end side end portion of the resin cover 47 covers a part of a base end side of the yoke 33. Furthermore, the resin cover 47 also covers the wiring member 45. The connector 41 is integrally formed with the resin cover 47.

Next, working of the fuel injection valve 1 will be explained.

When the electromagnetic coil 29 is not energized (i.e. when the driving current does not flow in the electromagnetic coil 29), the movable element 27 is forced in the valve closure direction by the coil spring 39, and the valve body 17 touches (is seated on) the valve seat 15b. In this case, the gap δ is present between a top end side end surface of the fixed core 25 and the base end side end surface of the movable core 27a. Here, in the present embodiment, this gap δ corresponds to a stroke of the movable element 27 (i.e. a stroke of the valve body 17).

When the electromagnetic coil 29 is energized and the driving current flows in the electromagnetic coil 29, the magnetic flux is generated in the closed magnetic path formed by the movable core 27a, the fixed core 25, and the yoke 33. A magnetic attraction force is then generated between the fixed core 25 and the movable core 27a, which face each other through the gap δ, by the magnetic flux. When this magnetic attraction force exceeds a resultant force of the urging force by the coil spring 39 and a fuel pressure that exerts on the movable element 27 in the valve closure direction, the movable element 27 starts moving in the valve open direction. Then when the valve body 17 separates from the valve seat 15b, a clearance (a fuel flow passage) is formed between the valve body 17 and the valve seat 15b, and injection of the fuel is started. In the present embodiment, when the movable element 27 moves by a distance δ that is equal to the gap δ in the valve open direction and the movable core 27a touches the fixed core 25, the movement in the valve open direction of the movable core 27a is stopped, and the movable core 27a is brought in a static valve open state.

When the driving current to the electromagnetic coil 29 is stopped, the magnetic attraction force diminishes, and then finally disappears. While the magnetic attraction force is diminishing, when the magnetic attraction force becomes smaller than the urging force of the coil spring 39, the movable element 27 starts moving in the valve closure direction. Then when the valve body 17 touches and is seated on the valve seat 15b, the valve body 17 of the valve part 7 is brought in a static valve closure state.

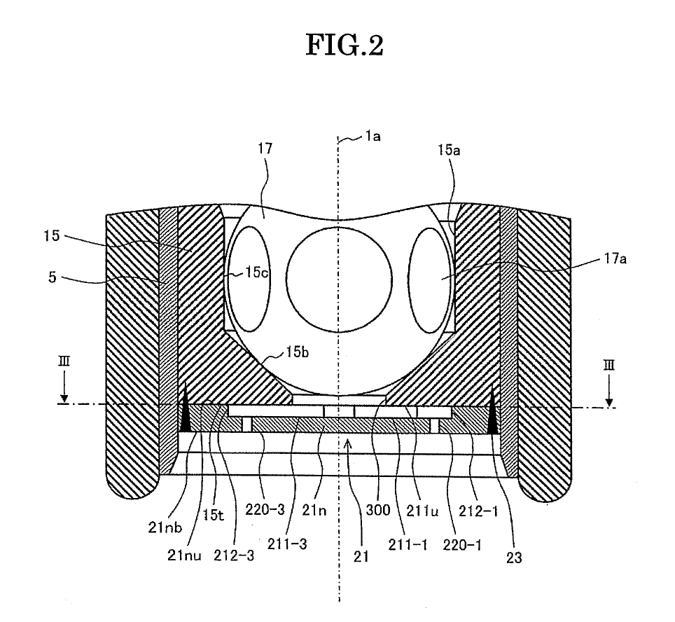

Next, each configuration of the valve part 7 and the fuel injection part 21 will be explained with reference to FIGS. 2 and 3. FIG. 2 is a longitudinal section drawing enlargedly showing a vicinity (a nozzle part) of a valve part 7 and a fuel injection part 21 of the fuel injection valve 1 shown in FIG. 1 (corresponding to a cross section taken along a line II-II in FIG. 3). FIG. 3 is a plan view of the nozzle plate 21n viewed from a line III-III in FIG. 1.

The top view of FIG. 3 is a top view of the nozzle plate 21n viewed from an entry side of the fuel injection orifice, and is a top view of an upper end surface 21nu side of the nozzle plate 21n. The upper end surface 21nu is a surface that faces a top end surface 15t of the valve seat member 15. An end surface of the nozzle plate 21n, which is an opposite side to the upper end surface 21nu, is a lower end surface 21nb.

In the present embodiment, as shown in FIG. 2, the nozzle plate 21n is formed by a plate member whose both end surfaces are flat, and the upper end surface 21nu and the lower end surface 21nb are parallel to each other. That is, the nozzle plate 21n is formed by a flat plate having a uniform thickness. Here, in the present embodiment, as shown in FIG. 3, the fuel injection valve 1 is configured so that the center axis line 1a crosses the nozzle plate 21n at a center 21no.

The top end surface (a lower end surface) 15t of the valve seat member 15 is formed by a flat surface that is perpendicular to the center axis line 1a. The nozzle plate 21n is fixed to the top end surface 15t of the valve seat member 15, and the top end surface 15t contacts or is contiguous to the upper end surface 21nu of the nozzle plate 21n.

As shown in FIG. 3, on the nozzle plate 21n, transverse passages 211-1, 211-2, 211-3 and 211-4, swirl chambers 212-1, 212-2, 212-3 and 212-4, and fuel injection orifices 220-1, 220-2, 220-3 and 220-4 are formed. The transverse passages 211-1, 211-2, 211-3 and 211-4 and the swirl chambers 212-1, 212-2, 212-3 and 212-4 form swirl passages 210-1, 210-2, 210-3 and 210-4 to provide a swirl force to the fuel in the upstream side of the fuel infection orifice 220. Four sets of swirl passages 210-1, 210-2, 210-3 and 210-4 and the fuel injection orifices 220-1, 220-2, 220-3 and 220-4 are formed in the same way as each other. Thus, in the following description, these are not distinguished, and these will be explained as the transverse passage 211, the swirl chamber 212 and the fuel injection orifice 220. However, in a case where structure or configuration of each set is changed, it will be explained as necessary.

As shown in FIG. 2, the conical valve seat 15b whose diameter is reduced toward the downstream side is formed at the valve seat member 15. A downstream end of the valve seat 15b is connected to a fuel introduction hole 300. A downstream end of the fuel introduction hole 300 opens to the top end surface 15t of the valve seat member 15. The fuel introduction hole 300 forms the fuel passage that introduces the fuel into the swirl passage 210.

In order for the swirl passage 210 to receive supply of the fuel from the fuel introduction hole 300, an upstream end portion of the transverse passage 211 is provided so as to face an opening surface of the fuel introduction hole 300. In the present embodiment, as shown in FIG. 3, the four transverse passages 211-1, 211-2, 211-3 and 211-4 are formed so that their upstream end portions communicate with each other. However, these four transverse passages 211-1, 211-2, 211-3 and 211-4 can be formed separately from each other.

In FIG. 2, the transverse passage 211, the swirl chamber 212 and the fuel injection orifice 220 are all formed on the nozzle plate 21n formed by one plate member. The nozzle plate 21n can be separated in a thickness direction, and be formed by a plurality of plates. For instance, the transverse passage 211 and the swirl chamber 212 are formed on one plate, and the fuel injection orifice 220 is formed on another plate. Then, by stacking or arranging these plates in layers, the nozzle plate 21n can be formed.

Furthermore, in the present embodiment, as shown in FIG. 2, the fuel injection orifice 220 is formed parallel to the center axis line 1a. However, the fuel injection orifice 220 can be formed so as to have an inclination angle that is greater than 0° with respect to the center axis line 1a. By differentiating an inclination direction of each fuel injection orifice 220, the fuel can be jetted in a plurality of directions.

In the present embodiment, as shown in FIG. 3, the swirl passage 210-1 and the fuel injection orifice 220-1 form one fuel passage, the swirl passage 210-2 and the fuel injection orifice 220-2 form one fuel passage, the swirl passage 210-3 and the fuel injection orifice 220-3 form one fuel passage, and the swirl passage 210-4 and the fuel injection orifice 220-4 form one fuel passage. The swirl passage 210-1 is formed by the transverse passage 211-1 and the swirl chamber 212-1, the swirl passage 210-2 is formed by the transverse passage 211-2 and the swirl chamber 212-2, the swirl passage 210-3 is formed by the transverse passage 211-3 and the swirl chamber 212-3, and the swirl passage 210-4 is formed by the transverse passage 211-4 and the swirl chamber 212-4.

In the present embodiment, the four fuel passage sets, each of which is formed by the swirl passage 210 and the fuel injection orifice 220, are provided on the nozzle plate 21n. Each of these four fuel passage sets is formed so as to extend radially from the center 21no side of the nozzle plate 21n toward an outer circumference of the nozzle plate 21n. That is, the transverse passage 211 is provided so as to extend radially from the center 21no side of the nozzle plate 21n toward the outer circumference of the nozzle plate 21n and is extended in a diameter direction of the nozzle plate 21n. Furthermore, the fuel passages are formed at angular intervals of 90° in a circumferential direction.

Regarding the number of the fuel passage sets, each of which is formed by the swirl passage 210 and the fuel injection orifice 220, it is not limited to four and it can be two or three, or five or more. Furthermore, only one set of the swirl passage 210 and the fuel injection orifice 220 may be formed.

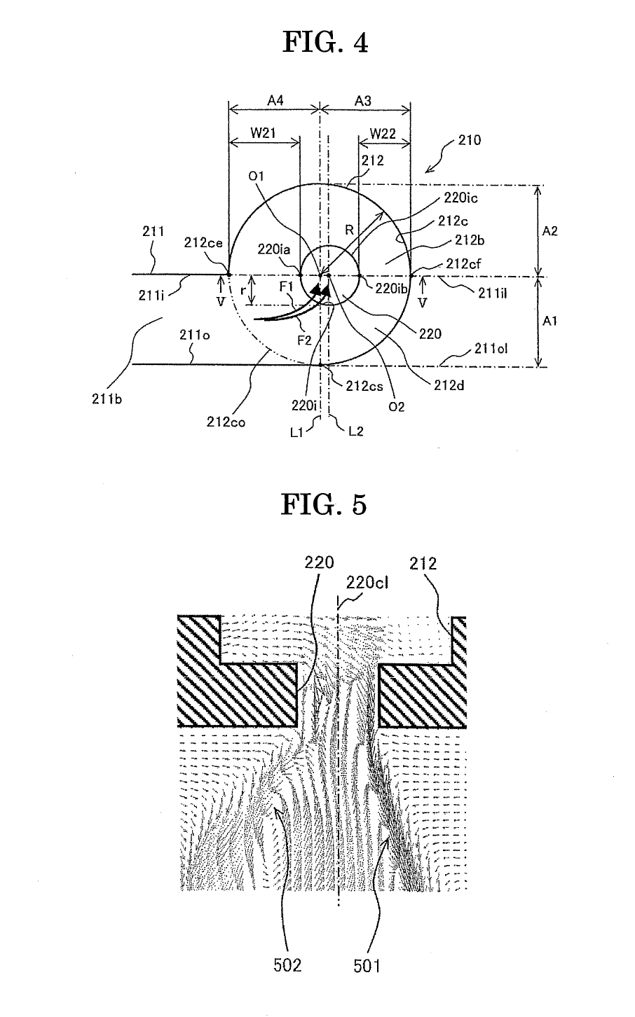

Here, a structural relationship between the swirl chamber 212 and the fuel injection orifice 220 will be explained in detail with reference to FIG. 4. FIG. 4 is a plan view enlargedly showing a swirl chamber 212 and a fuel injection orifice 220 (an enlarged plan view of IV area in FIG. 3).

The transverse passage 211 is connected to the swirl chamber 212 so as to be offset with respect to a center O1 of the swirl chamber 212. One width direction end part (side wall) 212o of the transverse passage 211 is connected to an inner circumferential wall 212c which is positioned in an upstream side in a flow direction of the swirl fuel, and the other width direction end part (side wall) 212i is connected to the inner circumferential wall 212c which is positioned in an downstream side in the flow direction of the swirl fuel. Therefore, the inner circumferential wall (side wall) 212c of the swirl chamber 212 has an opening 212co at the connection part of the transverse passage 211.

The inner circumferential wall 212c of the swirl chamber 212 is provided so as to form a circumference around the entry opening 220i of the fuel injection orifice 220 so that the fuel flowing into the swirl chamber 212 from the transverse passage 211 swirls. That is, a swirl flow passage 212d for the fuel is formed between the inner circumferential wall 212c of the swirl chamber 212 and the entry opening 220i of the fuel injection orifice 220.

The transverse passage 211 has a rectangular in shape in cross section (transverse section) that is perpendicular to the extending direction of the transverse passage 211 or the fuel flow direction. Side walls (side surfaces) 211o and 211i and a bottom surface 211b of the transverse passage 211 are formed by the nozzle plate 21n. Furthermore, an upper surface (a ceiling surface) 211u (see FIG. 2) of the transverse passage 211 is formed by the top end surface 15t of the valve seat member 15.

The side wall 211o of the transverse passage 211 is connected to the swirl chamber 212 at an angle in contact with the inner circumferential wall 212c of the swirl chamber 212. A downstream end of the side wall 211o is connected to a wall starting end portion 212cs of the inner circumferential wall 212c of the swirl chamber 212.

Furthermore, the side wall 211i of the transverse passage 211 is connected to the swirl chamber 212 at an angle where it intersects the inner circumferential wall 212c of the swirl chamber 212. Here, “intersect” means that the side wall 211i and its extension line are going across the inner circumferential wall 212c, and doesn't include a configuration that the side wall 211i and its extension line are in contact with the inner circumferential wall 212c. A downstream end of the side wall 211i is connected to a wall ending end portion 212ce of the inner circumferential wall 212c of the swirl chamber 212.

The wall starting end portion 212cs of the inner circumferential wall 212c of the swirl chamber 212 is an end portion which is positioned in the upstream side in the swirl direction of the fuel. The wall ending end portion 212ce of the inner circumferential wall 212c is an end portion which is positioned in the downstream side in the swirl direction of the fuel. In the wall ending end portion 212ce, a chamfering portion such as an inclined or rounded portion is sometimes formed. In such a case, an intersection point where imaginary lines which are formed by respectively extending the inner circumferential wall 212c and the side wall 211i intersect each other should be defined as the wall ending end portion (downstream side end portion) 212ce.

In the present embodiment, the inner circumferential wall 212c from the wall starting end portion 212cs of the swirl chamber 212 to the wall ending end portion 212ce is formed so as to be an arc shape in which radius R from the center O1 of the swirl chamber 212 is constant. That is, the inner circumferential wall 212c is formed by a part of a circumference of a perfect circle. On the other hand, the entry opening 220i of the fuel injection orifice 220 has a circular shape having a radius r smaller than the radius R of the inner circumferential wall 212c of the swirl chamber 212. With this structure, a bottom surface 212b of the swirl flow passage 212d is formed between the entry opening edge 220ic of the fuel injection orifice 220 and the inner circumferential wall 212c of the swirl chamber 212. Furthermore, in case that a center axis line of the fuel injection orifice 220 inclines with respect to the bottom surface 212b, even if a transverse section of the fuel injection orifice 220 has a circular shape, the entry opening 220 is elliptic, not circular. Regardless of the presence/absence of inclining, the center axis line of the fuel injection orifice 220 passes through a center O2 of the entry opening 220i.

FIG. 4 is a plan view and a projection drawing where the fuel injection orifice 220, the swirl chamber 212, and the transverse passage 211 are projected to a plane surface (projection plane) vertical to the center axis line 1a of the fuel injection valve 1. In FIG. 4, an extension line 211ol (first extension line) of the side wall 211o of the transverse passage 211 and an extension line 211il (second extension line) of the side wall 211i are shown by projecting. The first extension line 211ol is an imaginary line extending along the side wall 211o. The second extension line 211il is an imaginary line extending along the side wall 211i.

The second extension line 211il divides the bottom surface of the swirl chamber 212 (bottom surface 212b of the swirl flow passage 212d) into two areas A1 and A2. The area A1 is an area which is located in the side wall 211o or its extension line 211ol side with respect to the second extension line 211il. The wall starting end portion 212cs of the inner circumferential wall 212c is in the area A1, and formed by a swirl flow passage part in the wall starting end portion 212cs side of the inner circumferential wall 212c. The area A2 is an area positioned in an opposite side to the side wall 211o or its extension line 211ol side with respect to the second extension line 211il. The area A2 is formed by a swirl flow passage part in the wall ending end portion 212ce side of the inner circumferential wall 212c. Furthermore, it is defined that the areas A1 and A2 don't include the second extension line 211il itself.

A part of the entry opening edge 220ic of the fuel injection orifice 220 is arranged in the area A1 side over the second extension line 211il. That is, a part of the entry opening 220i of the fuel injection valve 220 opens toward the area A1 side.

In the present embodiment, the center O2 of the entry opening 200i of the fuel injection orifice 220 is positioned on the second extension line 211il. Because of this, the entry opening 220i of the fuel injection orifice 220 is protruded toward the area A1 side over the second extension line 211il by the radius r of the fuel injection orifice 220. Therefore, the entry opening edge 220ic of the fuel injection orifice 220 intersects with the second extension line 220il at two points 220ia and 220ib. That is, the entry opening 220i of the fuel injection orifice 220 is arranged so that the second extension line 220il and the entry opening edge 220ic of the fuel injection orifice 220 are intersected at the two points 220ia and 220ib. Furthermore, a protrusive degree of the entry opening 220i toward the area A1 side is not limited to the size of the radius r of the fuel injection orifice 220. The protrusive degree may be bigger than the radius r and may be smaller than the radius r.

In the present embodiment, in addition, the center O2 of the entry opening 200i of the fuel injection orifice 220 is arranged at a position which is shifted from the center O1 of the swirl chamber 212 in a direction along the second extension line 211il. That is, the center O2 of the entry opening 220i of the fuel injection orifice 220 is eccentric with respect to the center O1 of the swirl chamber 212.

Here, divisions of the swirl chamber 212, which are different from the area A1 and A2, will be explained. First, a line segment L1, which pass through the center O1 of the swirl chamber 212 and is perpendicular to the second extension line 211i, is imaged. Next, the swirl chamber 212 is divided into two areas A3 and A4 by the line segment L1. The area A3 is a division opposite to a side where the transverse passage 211 is connected with respect to the line segment L1. The area A4 is a division in a side where the transverse passage 211 is connected with respect to the line segment L1. The area A4 is formed of an uppermost upstream side section and a lowermost downstream side section of the swirl flow passage 212d. The area A3 is formed of a middle flow passage section of the swirl flow passage 212d. Furthermore, it is defined that the areas A3 and A4 don't include the line segment L1 itself.

A shifting direction of the center O2 is a direction along the second extension line 211il and is in a side of an intersection point 212cf positioned in an opposite side to the wall ending end portion 212ce of the inner circumferential wall 212c across the entry opening 220i of the fuel injection orifice 220. The intersection point 212cf is the intersection point of the second extension line 211il and the inner circumferential wall 212c.

In the present embodiment, as the center O1 of the swirl chamber 212 and the center O2 of the entry opening 220i are arranged on the second extension line 211il, the center O2 of the entry opening 220i exists at a position which is shifted from the center O1 of the swirl chamber 212 toward the intersection point 212cf on the second extension line 211il. Furthermore, on the second extension line 211il, the center O2 of the entry opening 210i is arranged in the area A3 near to the 212cf side than the center O1, which is a center point dividing a distance between the intersection point 212cf and the wall ending end portion 212ce into two equal parts.

However, the shifting direction of the center O2 is not limited to the direction disclosed in the present embodiment, and may be disposed so that the center O2 of the entry opening 220i is positioned in the area A3. In this case, a line segment (imaginary line segment) L2, which passes through the center O2 of the entry opening 220i and is perpendicular to the second extension line 211il, doesn't overlap with the imaginary line segment L1 and is parallel to the imaginary line segment L1. That is, there is a substantially distance between the imaginary line segment L1 and the imaginary line segment L2, and they have a parallel relationship each other. Here, the term “there is a substantially distance” means that a case that the distance is zero is not included.

As compared with a case that the center O2 of the entry opening 220i of the fuel injection orifice 220 corresponds to the center O1 of the swirl chamber 212, the center O2 is arranged in the intersection point 212cf side. Therefore, in a flow passage width W21 and a flow passage width W22, which are formed in both sides of the entry opening 220i in the direction of the second extension line 211il, the flow passage width W22 is narrower than the flow passage width W21. The flow passage width W21 corresponds to a distance between the wall ending end portion 212ce, which is an imaginary intersection point of the second extension line 211il and the inner circumferential wall 212c; and a first intersection point 220ia of the second extension line 211il and the entry opening edge 212ic. The flow passage width W22 corresponds to a distance between a second intersection point 220ib of the second extension line 211il and the entry opening edge 212ic; and the intersection point 212cf of the second extension line 211il and the inner circumferential wall 212c, the intersection point 212cf being in the wall starting end portion 212cs side.

A fuel flow, which flows into the fuel injection orifice 220 from the swirl chamber 212 and is jetted from the fuel injection orifice 220, will be explained with reference to FIG. 5. FIG. 5 is a drawing showing an analytical result of a fuel flow at a cross section taken along a line V-V in FIG. 4.

The fuel flow flowing into the swirl chamber 212 from the transverse passage 211 flows along the inner circumferential wall 212c of the swirl chamber 212, and swirls around the entry opening 220i of the fuel injection orifice 220. At this stage, the fuel is provided with the swirl force. The fuel flow provided with the swirl force flows into the fuel injection orifice 220 while swirling. The fuel jetted from the fuel injection orifice 220 forms a liquid film while keeping the swirl force, and further spreads as a droplet state. Atomized fuel spray is then formed.

In the present embodiment, the entry opening 220i of the fuel injection orifice 220 is formed so as to protrude toward the area A1 side over the extension line 211il of the side wall 211i, so a part of fuel flowing into the swirl chamber 212 from the transverse passage 211 flows into the fuel injection orifice 220 without swirling in the swirl chamber 212. That is, the fuel tends to flow into the fuel injection orifice 220. A tendency of flowing into the fuel injection orifice 220 in a fuel flow can be adjusted by modifying a protruding degree toward the area A1 side in the fuel injection orifice 220. Thereby, a flow volume of a fuel flowing into the fuel injection orifice 220, that is, injection amount can be adjusted. Generally, when the protruding degree toward the area A1 side is increased, the flow volume of fuel flowing into the fuel injection orifice 220 (injection amount) is increased.

In FIG. 5, as a shade of an arrow showing the fuel flow becomes darker, the flow velocity increases. In the present embodiment, in a 501 side where the fuel flows into the fuel injection orifice 220 without sufficiently swirling in the swirl chamber 212, a fuel velocity in an axial direction of the fuel injection orifice 220 (axial direction velocity) is large, and a fuel spray with strong penetration force is formed. Furthermore, in the 501 side, a spray angle is small, and penetration is long. On the other hand, in a 502 side, a fuel flow which has gotten a swirl force by swirling in the swirl chamber 212 is jetted from the fuel injection orifice 220. Therefore, as compared with in the 501 side, in the 502 side, an axial direction velocity of the fuel is small, and a fuel spray with weak penetration force is formed. Furthermore, as compared with in the 501 side, in the 502 side, the swirl force is strong, so the spray angle is large, and the penetration is short.

Furthermore, in the present embodiment, the center O2 of the entry opening 220i of the fuel injection orifice 220 is shifted from the center O1 of the swirl chamber 212 to be arranged in the area A3 shown in FIG. 4. That is, the center O2 of the entry opening 220i of the fuel injection orifice 220 is arranged at a position shifted from the center O1 of the swirl chamber 212 toward the intersection point 212cf side in a direction along the second extension line 211il. By adjusting a shift amount in the direction along the second extension line 211il from the center O1 of the swirl chamber 212, the spray angle of the fuel spray can be adjusted.

Furthermore, in a comparison between flow velocity of the fuel flow F2 and flow velocity of the fuel flow F1, the flow velocity of the fuel flow F2 is faster than the flow velocity of the fuel flow F1. The fuel flow F1 is a flow that the fuel flowed into the swirl chamber 212 tries to flow into the fuel injection orifice 220 in further upstream side. The fuel flow F2 is a flow that the fuel flowed into the swirl chamber 212 tries to flow into the fuel injection orifice 220 in further downstream side.

The fuel flow having a fast fuel velocity can be flowed into the fuel injection orifice 220 by shifting the center O2 of the entry opening 220i of the fuel injection orifice 220 toward the area A3 side with respect to the imaginary line segment L1. Because of this, rectilinear lines of the fuel flow inside the fuel injection orifice 220 increase, and velocity component in a direction of a center axis line 220cl of the fuel injection orifice 220 gets large. The rectilinear lines of the fuel flow inside the fuel injection orifice 220 increase, and thereby the spray angle of the fuel spray jetted from the fuel injection orifice 220 can be narrow. Therefore, the present embodiment is available in case that not only adjustment of the spray angle in the fuel spray but also the fuel spray with a narrow spray angle is required.

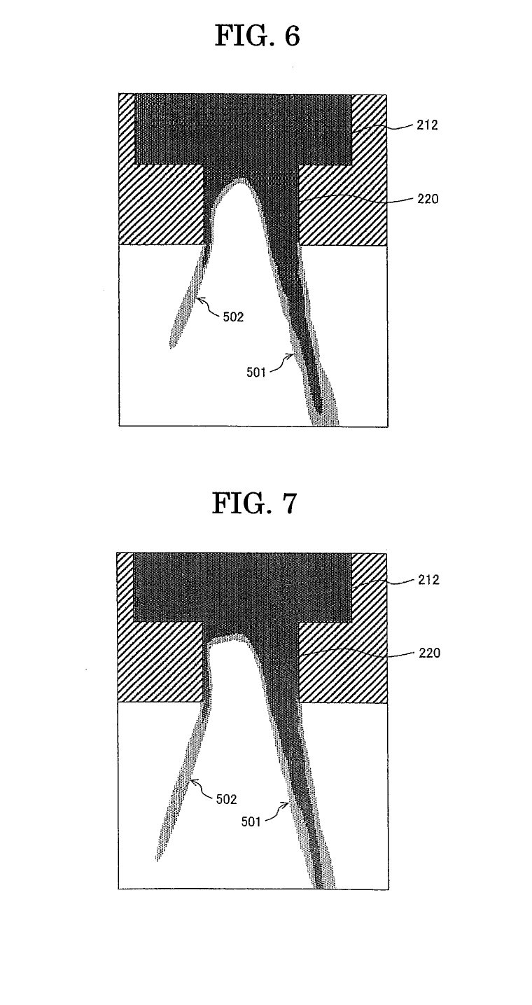

Here, a fuel liquid film distribution formed in the fuel injection orifice in the present embodiment will be explained with reference to FIG. 6 and FIG. 7. FIG. 6 is a longitudinal section drawing (a cross section taken along a V-V line in FIG. 4) showing a fuel liquid film distribution in an inside of the fuel injection orifice and a vicinity thereof, when arranging an entry opening of the fuel injection orifice in a center of the swirl chamber. FIG. 7 is a longitudinal section drawing (a cross section taken along a V-V line in FIG. 4) showing a fuel liquid film distribution in an inside of the fuel injection orifice and a vicinity thereof, when arranging an entry opening to be shifted to area A3 side from the center of the swirl chamber. Furthermore, in FIG. 6 and FIG. 7, a state of the liquid film is shown with two kinds of shade. A dark part is where a proportion of the fuel is 100%, and a pale part is where the proportion of the fuel is less than 100% because air is mixed therein.

In both of FIG. 6 and FIG. 7, the fuel liquid film of the 501 side is thicker as compared with the fuel liquid film of the 502 side.

However, in comparison between FIG. 6 and FIG. 7, it is found that the liquid film in the 502 side is very thin inside the fuel injection orifice 220 in FIG. 7, with respect to FIG. 6. Conversely, in the 501 side, the fuel flowing amount to the fuel injection orifice 220 increases, so the fuel liquid film gets thick. Furthermore, rectlinearity of the fuel flowing into the fuel injection orifice 220 increases, so the fuel spray travel gets long. The 501 side is located in the upstream side with respect to the 502 side in the swirl direction of the fuel.

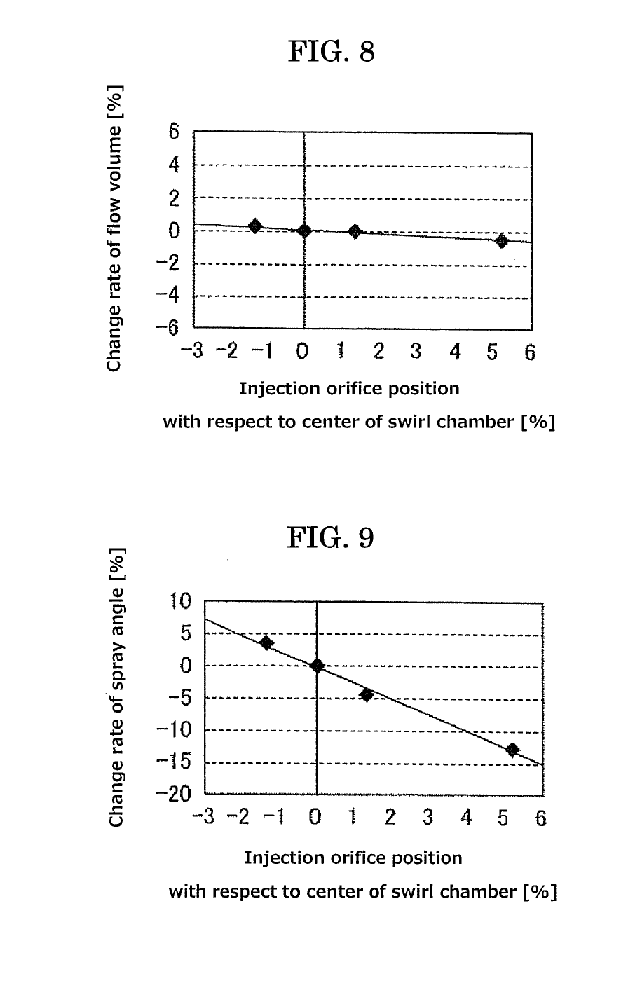

Change rates of a fuel injection amount (flow volume) and spray angle in the present embodiment will be explained with reference to FIG. 8 and FIG. 9. FIG. 8 is a drawing showing an analytical result of a change rate of flow volume in the present embodiment, when a position of the entry opening of the fuel injection orifice is changed. FIG. 9 is a drawing showing an analytical result of a change rate of spray angle in the present embodiment, when a position of the entry opening of the fuel injection orifice is changed. Furthermore, in FIG. 8 and FIG. 9, the horizontal axis represents a ratio of a shift amount in an opening position of the entry opening 220i with respect to a diameter of the swirl chamber 212.

As found from FIG. 8 and FIG. 9, when the opening position of the entry opening 220i is shifted, the spray angle largely changes, but the flow volume hardly changes. That is, according to the structure of the present embodiment, even if the spray angle is adjusted after the fuel injection amount is adjusted, the spray angle can be adjusted without changing the fuel injection amount. Furthermore, from FIG. 9, it is found that the spray angle gets narrow by shifting the center O2 of the entry opening 220i toward the area A3 side.

In the present embodiment, it is possible to adjust the spray angle in the fuel spray by shifting the center O2 of the entry opening 220i toward the area A3 and arranging it, after the fuel injection amount is determined by adjusting the protrusive degree of the entry opening 220i of the fuel injection orifice 220 toward the area A1 side. Therefore, to adjust the fuel injection amount and the spray angle is made to be easy, so design freedom of the fuel injection valve can be improved.

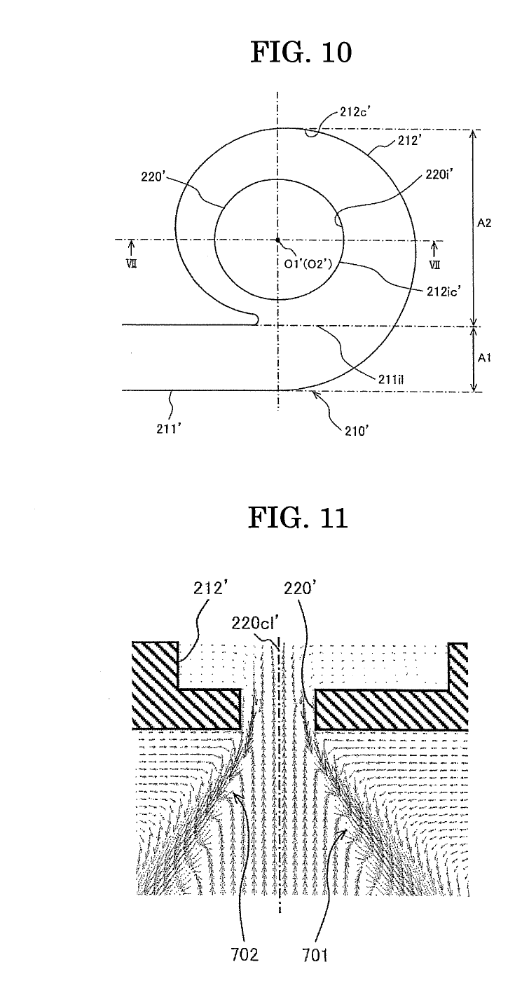

In a comparative example, a fuel flow, which flows into the fuel injection orifice 220′ from the swirl chamber 212′ and is jetted from the fuel injection orifice 220′, will be explained with reference to FIG. 10 and FIG. 11. FIG. 10 is a plan view showing a configuration of a transverse passage, a swirl chamber, and a fuel injection orifice in a comparative example. FIG. 11 is a drawing showing an analytical result of a fuel flow at a cross section taken along a line VII-VII in FIG. 10.

As for the comparative example shown in FIG. 10, the whole of an entry opening 220i′ of the fuel injection orifice 220′ is located at the area A1 side with respect to the extension line (second extension line) 211il of the side wall 211i. That is, the second extension line 211il doesn't intersect the opening edge 212ic′ of the entry opening 220i. In this case, the fuel flow provided with the swirl force flows throughout an entire circumference of the entry opening 220i′ of the fuel injection orifice 220′. Because of this, in the case of the comparative example, as shown in FIG. 11, as the spray form, the spray angle and the fuel flow velocity in a 701 side and the spray angle and the fuel flow velocity in a 702 side are equal to each other.

In the present embodiment, in the 501 side, since the swirl force of the fuel flow is weak, an atomization effect using the swirl force is reduced. However, since the center axis 220lcl′ direction velocity is high, an atomization performance can be prevented from lowering, or can be kept or improved by using frictional heat between the fuel flow and the air. Accordingly, in the present embodiment, it is possible to readily adjust the fuel injection amount while suppressing the lowering of the atomization performance. Furthermore, as described above, although the spray form of the fuel (the angle and size of the spray or droplet) is changed, as compared with a case where cross-sectional areas of the transverse passage 211 and the fuel injection orifice 220 are changed in order to adjust the fuel flow volume, a change amount of the spray form can be small.

The entry opening 212i of the fuel injection orifice 220 is protruded toward the area A1 side, and the protrusive degree is modified. Thereby, the fuel injection amount can be adjusted. Here, when to adjust the spray angle is required, the protrusive degree to the area A1 side in the entry opening 212i is modified in order to adjust the spray angle, and thereby, the fuel injection amount is also changed. If design of an orifice diameter of the fuel injection orifice, length of the fuel injection orifice, a size (diameter) of the swirl chamber, etc. is redone in order to adjust both of the fuel injection amount and the spray angle, considerable labor and time are needed.

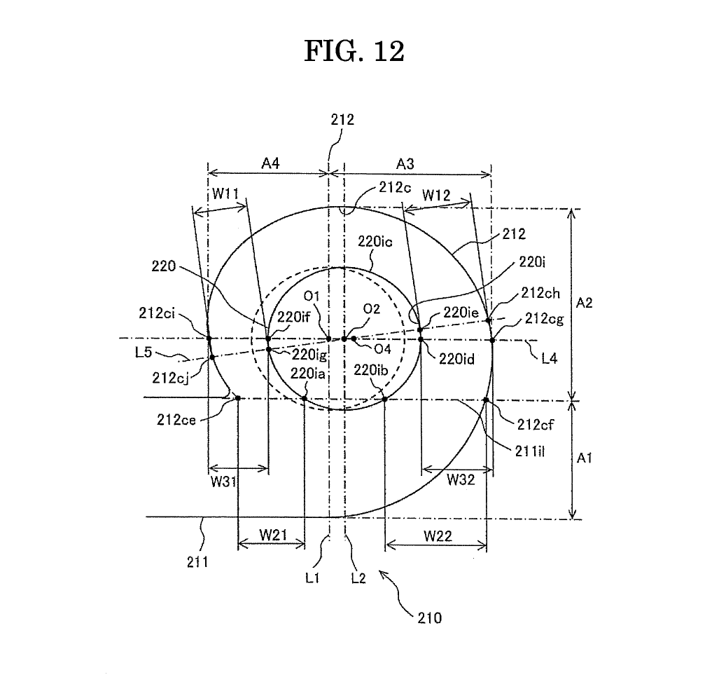

Hereinafter, a modified example where the shape of the swirl chamber 212 according to the present invention will be explained with reference to FIGS. 12 to 14.

In FIG. 4, the inner circumferential wall 212c of the swirl chamber 212 is formed into a perfect circle. However, as shown in FIG. 12 to FIG. 14, the inner circumferential wall 212c of the swirl chamber 212 may be formed into a spiral shape such as a spiral curve or an involute curve. Furthermore, in case that the inner circumferential wall 212c is formed with the spiral curve, the center O1 of the swirl chamber 212 corresponds to a swirl center of the spiral curve. Furthermore, in case that the inner circumferential wall 212c is formed with the involute curve, the center O1 of the swirl chamber 212 corresponds to a center of a base circle. In this manner, the center O1 of the swirl chamber 212 is defined as a geometric center or a center of circle set for construction.

FIG. 12 is a plan view enlargedly showing a swirl chamber and a fuel injection orifice in an example where a shape of the swirl chamber is modified (the enlarged plan view of IV area in FIG. 3).

The inner circumferential wall 212c of the swirl chamber 212 in the present embodiment is formed with a spiral curve or an involute curve. The second extension line 211il, the areas A1 to A4, and the imaginary line segments L1, L2 are defined as well as in FIG. 4. In FIG. 12, the entry opening 220i in case that the center O2 of the entry opening 220i of the fuel injection orifice 220 is arranged on the center O1 of the swirl chamber 212 is shown with a broken line.

The entry opening 220i of the fuel injection orifice 220 is protruded toward the area A1 side over the second extension line 211il. Therefore, the second extension line 211il intersects with the entry opening edge 220ic of the fuel injection orifice 220 at two intersection points 220ia and 220ib.

Furthermore, the center O2 of the entry opening 220i of the fuel injection orifice 220 is located at a position separated from the center O1 of the swirl chamber 212, and arranged in the area A3. As well as in FIG. 4, there is a substantially distance between the imaginary line segment L1 and the imaginary line segment L2, and they have a parallel relationship each other.

Although the center O2 of the entry opening 220i is arranged in the area A3, it is disposed in the intersection point 212ci side with respect to a center point O4 which divides a distance between the intersection point 212cg and the intersection point 212ci into two equal parts on the line segment L4. The line segment L4 is an imaginary line segment which passes through the center O1 of the swirl chamber 212 and the center O2 of the entry opening 220i, and is parallel to the second extension line 211il. Although there is no need that the imaginary line segment L4 and the second extension line 211il are parallel each other, hereinafter the case where the imaginary line segment L4 and the second extension line 211il are parallel each other will be explained.

In the present example, the center O2 of the entry opening 220i is located at a position separated from the center O1 of the swirl chamber 212, and arranged in the area A3. However, in flow passage width W21 and W22, which are formed in both sides of the entry opening 220i on the second extension line 211il, the flow passage width W22 is larger than the flow passage width W21. The flow passage width W21 is a gap (distance) between the wall ending end portion 212ce and the intersection point 220ia. The flow passage width W22 is a gap (distance) between the intersection point 220ib and the intersection point 220cf. The wall ending end portion 212ce and the intersection points 220ia, 220ib, 220cf are defined as well as in FIG. 4.

In flow passage width W31 and W32, which are formed in both sides of the entry opening 220i on the imaginary line segment L4, the flow passage width W32 is larger than the flow passage width W31. The flow passage width W31 is a gap (distance) between the intersection point 212ci and the intersection point 220if. The flow passage width W32 is a gap (distance) between the intersection point 220id and the intersection point 220cg. The intersection points 212cg and 212ci are intersection points of the imaginary line segment L4 and the inner circumferential wall 212c. The intersection points 212id and 212if are intersection points of the imaginary line segment L4 and the entry opening edge 220ic.

Furthermore, in the present example, a flow passage width W11 and W12, which cannot be defined in FIG. 4, can be defined. The flow passage width W11 and W12 are formed in both sides of the entry opening 220i on a line segment L5. The flow passage width W12 is larger than the flow passage width W11. The line segment L5 is an imaginary line segment which passes through the center O2 of the entry opening 220i and the center 21no of the nozzle plate 21n. The flow passage width W11 is a gap (distance) between the intersection point 212cj and the intersection point 220ig. The flow passage width W12 is a gap (distance) between the intersection point 212ie and the intersection point 220ch. The intersection points 212ch and 212cj are intersection points of the imaginary line segment L4 and the inner circumferential wall 212c. The intersection points 220ie and 220ig are intersection points of the imaginary line segment L4 and the entry opening edge 220ic.

Also according to the structure of the present example, the same effect as the structure in FIG. 4 can be obtained.

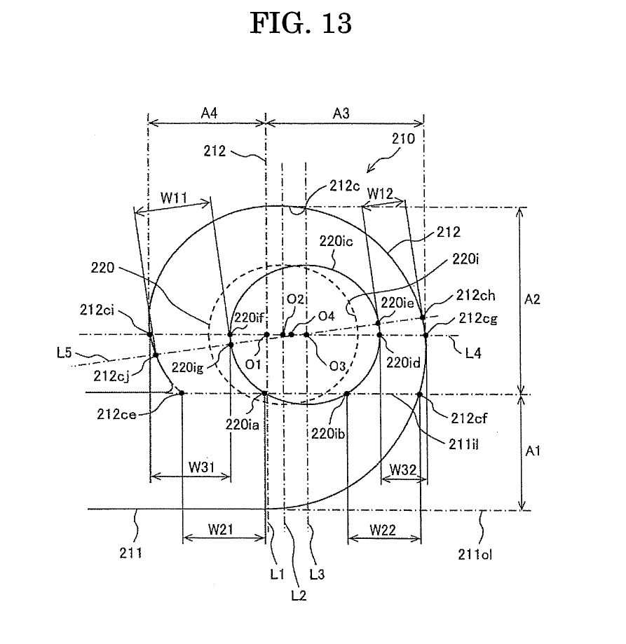

FIG. 13 is a plan view showing an example where a position of the fuel injection valve with respect to the swirl chamber is changed in the modified example of FIG. 12. The second extension line 211il, the areas A1 to A4, and the imaginary line segments L1, L2 are defined as well as in FIG. 4. Furthermore, the imaginary line segments L4, L5, and the flow passage width W11, W12, W21, W22, W31, W32 are defined as well as in FIG. 12.

In the present example, the center of the fuel injection orifice 220 is further shifted from a position of the center O2 to a position of the center O3. In FIG. 13, the entry opening 220i in case that the center of the entry opening 220i of the fuel injection orifice 220 is located at the position of O2 in FIG. 12 is shown with a broken line. Furthermore, the line segment L3 is an imaginary line segment which passes through the center O3 of the fuel injection orifice 220 and a perpendicular line segment to the second extension line 211il.

The center O3 of the entry opening 220i is arranged in the area A3 and in the intersection point 212cf side with respect to the center O4, which divides a distance between the intersection point 212cf and the wall ending end portion 212ce into two equal parts on the line segment L4.

In the present example, the flow passage width W22 is smaller than the flow passage width W21. The flow passage width W12 is smaller than the flow passage width W11. The flow passage width W32 is smaller than the flow passage width W31. In this manner, even if the inner circumferential wall 212c of the swirl chamber 212 is formed with a spiral curve or an involute curve, it is possible that the flow passage width W12, W22, or W32 is small with respect to the flow passage width W11, W21, or W31.

Also according to the structure of the present example, the same effect as the structure in FIG. 4 can be obtained.

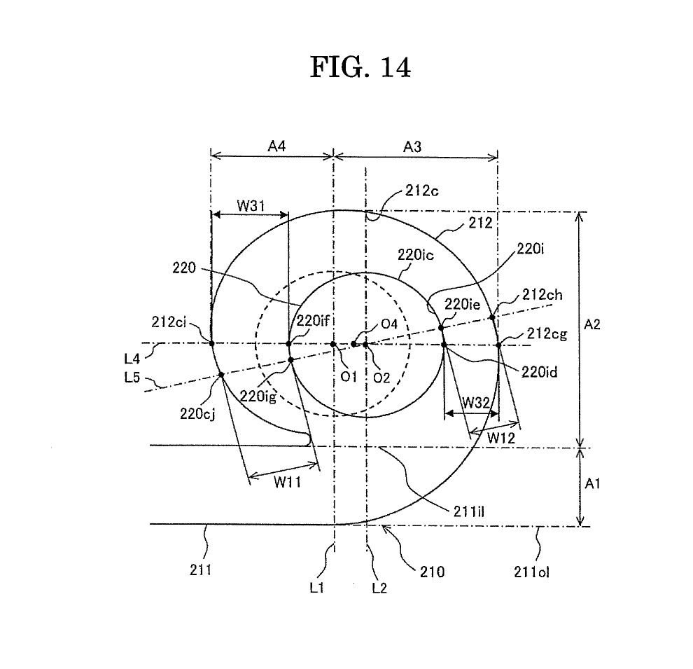

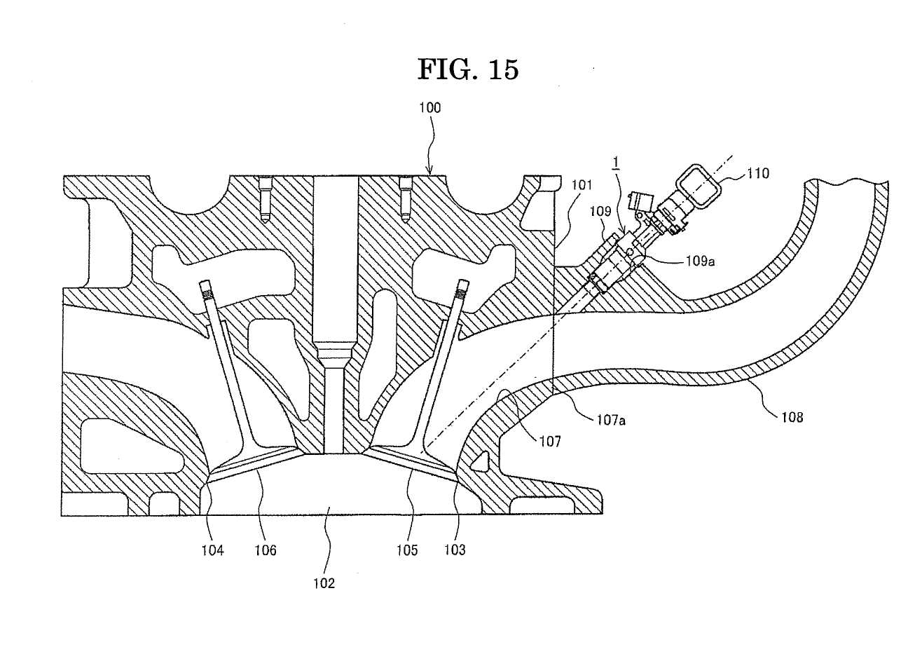

FIG. 14 is a plan view enlargedly showing the swirl chamber and the fuel injection orifice in the example where the shape of the swirl chamber is further modified (the enlarged plan view of IV area in FIG. 3). The second extension line 211il, the areas A1 to A4, and the imaginary line segments L1, L2 are defined as well as in FIG. 4. Furthermore, the imaginary line segments L4, L5, the flow passage width W11, W12, W31, W32, and the center point O4 are defined as well as in FIG. 12.

The inner circumferential wall 212c of the swirl chamber 212 in the present example is formed with a spiral curve or an involute curve. However, the whole of an entry opening 220i of the fuel injection orifice 220 is formed in the center O1 side of the swirl chamber 212 with respect to the second extension line 211il.

In such a form, the flow passage width W21 and W22 cannot be defined. However, the flow passage width W11, W12, W21, and W22 can be defined as well as in FIG. 12 and FIG. 13. Furthermore, in the flow passage width W11 and W12, the flow passage width W12 can be large or small with respect to the flow passage width W11. Furthermore, in the flow passage width W31 and W32, the flow passage width W32 can be large or small with respect to the flow passage width W31. Regarding to the large/small relation among the flow passage width W11, W12, W21, and W22, the relation is determined depend on a positional relation of the center O2 of the entry opening 220i with respect to the center point O4, and is the same relation as in FIG. 12 and FIG. 13.

In the case of the present example, an effect of adjusting a flow volume depending on protruding the entry opening 220i of the fuel injection orifice 220 toward the area A1 side cannot be obtained. However, by arranging the center of the entry opening 220i of the fuel injection orifice 220 in the area A3 side, an effect of narrowing the spray angle or an effect of adjusting the spray angle can be obtained.

Furthermore, all of the line segments L1 to L5 described above are straight lines.

In a comparative example in FIG. 10, the entry opening 220i′ of the fuel injection orifice 220′ is arranged so that its center O2′ corresponds to the center O1′ of the swirl chamber 212′. Thereby, it is possible to maximize a velocity component in the swirl direction of the fuel flowing into the fuel injection orifice 220′. On the other hand, in the embodiment and the modified example described above, the center O2 of the entry opening 220i is shifted from the center O1 (first position) of the swirl chamber 212 to a second position, and arranged. The first position is where the velocity component in the swirl direction of the fuel can be maximized. The second position is where the velocity component in the swirl direction is reduced, and where a velocity component in a center axis line 220cl direction of the fuel injection orifice 220 is enhanced. Thereby, rectilinearity of the fuel having flowed into the fuel injection orifice is improved, so the spray angle can be made narrow.

The internal combustion engine in which the fuel injection valve of the present invention is mounted will be explained with reference to FIG. 15. FIG. 15 is a cross section of the internal combustion engine in which the fuel injection valve 1 is mounted.

A cylinder 102 is formed in an engine block 101 of an internal combustion engine 100, and an intake port 103 and an exhaust port 104 are provided at a top of the cylinder 102. The intake port 103 is provided with an intake valve 105 that opens/closes the intake port 103. The exhaust port 104 is provided with an exhaust valve 106 that opens/closes the exhaust port 104. An intake pipe 108 is connected to an entry side end portion 107a of an intake passage 107 that is formed at the engine block 101 and communicates with the intake port 103.

A fuel pipe 110 is connected to the fuel supply port 2 (see FIG. 1) of the fuel injection valve 1.

A fixing portion 109 for the fuel injection valve 1 is formed at the intake pipe 108, and the fixing portion 109 is provided with an insertion port 109a into which the fuel injection valve 1 is inserted. The insertion port 109a penetrates the intake pipe 108 up to an inner wall surface (intake passage) of the intake pipe 108, and the fuel jetted from the fuel injection valve 1 inserted in the insertion port 109a is jetted into the intake passage. In a case of two-direction spray, a target is an internal combustion engine having a form where two intake ports 103 are provided at the engine block 101, and the fuel sprays are injected toward each intake port 103 (each intake valve 105).

The present invention is not limited to the above embodiment or modification example although having been explained above on the basis of them. Therefore, a part of the configuration could be removed, or another element that is not disclosed in the above embodiment or modification example could be added. Furthermore, in the embodiment and the modification example, the element that is disclosed in the above embodiment or modification example can be changed or added.

1. A fuel injection valve comprising:
a valve body;
a fuel injection orifice provided in a downstream side of a valve seat which the valve body moves toward and away from;
a swirl chamber having a bottom surface on which an entry opening of the fuel injection orifice opens and an inner circumferential wall surrounding the bottom surface, the swirl chamber having:
a swirl passage for a fuel, the swirl passage formed between the inner circumferential wall and the entry opening; and
a transverse passage whose downstream end is opened in the inner circumferential wall of the swirl chamber in order to provide the fuel into the swirl chamber, the transverse passage having:
one width direction end part connected to an upstream side of the inner circumferential wall in a flow direction of a swirl fuel; and
the other width direction end part connected to a downstream side of the inner circumferential wall in the flow direction of the swirl fuel, and
when imaging an extension line formed by extending the other width direction end part of the transverse passage to a swirl chamber side, and a straight line segment passing a center of the swirl chamber and being perpendicular to the extension line,
a center of the entry opening of the fuel injection orifice being positioned to be shifted from the center of the swirl chamber along the extension line, and in two areas formed by dividing the swirl chamber into two with the straight line segment, the center of the entry opening of the fuel injection orifice being arranged in an area opposite to an area to which the transverse passage is connected.

2. The fuel injection valve as claimed in claim 1,
wherein:
when imaging a first line segment passing the center of the entry opening and being parallel to the extension line, the first line segment intersects with an opening edge of the entry opening at two points.

3. The fuel injection valve as claimed in claim 2,
wherein:
in flow passage width which is formed in both side of the entry opening on the first line segment, the flow passage width in the upstream side in the flow direction of the swirl fuel is smaller than the flow passage width in the downstream side in the flow direction of the swirl fuel.

4. The fuel injection valve as claimed in claim 3,
wherein:
the inner circumferential wall of the swirl chamber is constituted of an arc surface having a constant radius.

5. The fuel injection valve as claimed in claim 4,
wherein:
the center of the swirl chamber is on the first line segment, and the first line segment corresponds with the extension line.

6. The fuel injection valve as claimed in claim 2,
wherein:
the inner circumferential wall of the swirl chamber is formed with a spiral curve or an involute curve.

7. A fuel injection valve comprising:
a valve body;
a fuel injection orifice provided in a downstream side of a valve seat which the valve body moves toward and away from;
a swirl chamber having an entry opening of the fuel injection orifice and a swirl passage for a fuel, the swirl passage formed around the entry opening;
a transverse passage to provide the fuel into the swirl chamber; and
a nozzle plate on which the fuel injection orifice, the swirl chamber, and the transverse passage are formed,
wherein:
in flow passage width which is formed in both side of the entry opening on a line segment passing a center of the entry opening of the fuel injection orifice and a center of the nozzle plate, the flow passage width in the upstream side in the flow direction of the swirl fuel is smaller than the flow passage width in the downstream side in the flow direction of the swirl fuel.

8. A fuel injection valve comprising:
a valve body;
a fuel injection orifice provided in a downstream side of a valve seat which the valve body moves toward and away from;
a swirl chamber having an entry opening of the fuel injection orifice and a swirl passage for a fuel, the swirl passage formed around the entry opening; and
a transverse passage to provide the fuel into the swirl chamber,
wherein:
a center of the entry opening of the fuel injection orifice is arranged to be shifted from a first position to a second position,
the first position being a position where a velocity component in a swirl direction of a fuel flowing into the fuel injection orifice is max,
the second position being a position where the velocity component in the swirl direction gets small and where a velocity component in a center axis direction of the fuel injection orifice gets large.

9. The fuel injection valve as claimed in claim 8,
wherein:
in change rates of spray angle and flow volume with respect to positional shift from the first position to the second position, the change rate of spray angle is larger than the change rate of the flow volume.

10. The fuel injection valve as claimed in claim 8,
wherein:
in terms of a fuel liquid film formed inside the fuel injection orifice, an upstream side of the swirl passage is thicker than an downstream side of the swirl passage.
